(19) United States
(12) Patent Application Publication
(10) Pub. No.: US 2016/0004520 A1
(43) Pub. Date: Jan. 7, 2016

(54) OPTIMIZATION OF COMPUTER MODULES FOR THE DEPLOYMENT OF A COMPUTER SERVICE

(71) Applicant: ARROW ECS, Courbevoie (FR)

(72) Inventors: Eric GOURMELEN, Courbevoie (FR); Jean-Charles RAGONS, Courbevoie (FR)

(21) Appl. No.: 14/770,219

(22) PCT Filed: Mar. 3, 2014
(86) PCT No.: PCT/FR2014/050463

§ 371 Date: Aug. 25, 2015

(30) Foreign Application Priority Data
Mar. 25, 2013 (FR) 13 52667

(51) Int. Cl. G06F 9/445; G06F 17/30; G06F 9/44; H04L 29/08

(52) U.S. Cl. CPC G06F 8/60; H04L 67/16; G06F 17/30598; G06F 8/70

(57) ABSTRACT

The invention relates to an automated selection of optimal computer modules for deploying a computer service. For this purpose, the following steps are provided:
obtaining data relating to multiple computer modules, and, depending on said module data, classifying the modules at least by categories;
obtaining data relating to the computer service, and, depending on said service data, defining one or multiple service types constituting said computer service, and
establishing a correspondence between said service types and at least a portion of said module categories, in order to generate a list of modules suitable for being used to implement each service type.

Modules can then be selected in said list with a view to deploying the service.

The invention relates to evaluating the optimum computer modules for deployment of a computer service composed of these software modules. One advantageous but non-limiting application lies in implementing a service for hosting computer resources on a remote server, in particular for a company using these resources, for example in a context of cloud computing.

In particular, the invention aims to simulate, construct, and deploy a computer service based on computer modules (software and/or hardware), and, in an optional but preferred embodiment, to manage the invoicing related to the use and resale of this service.

The invention can thus be used by IT service providers or resellers of computer modules, to deliver all types of service such as virtual servers, email services, database services, office application services, security services (antivirus, firewall, etc.), or any combination thereof (for example a virtual secure email server).

Conventional embodiments are known in which an IT service provider simply searches the market for a set of modules such as software products, then buys them and tests their operation. The service is placed in production completely manually; each software component is purchased in anticipation of a specific intended use.

Many technical specialists must be mobilized when providing computer services, in order to select the products as well as test and integrate them. Once deployed, the software licenses associated with these products represent a major investment even though the service is not yet being delivered.

The present invention improves the situation.

It concerns a method, implemented by computer means, for selecting optimal computer modules for deployment of a computer service, the method comprising the steps of:
obtaining data relating to a plurality of computer modules, and, depending on these module data, classifying the modules at least by categories,
obtaining data relating to the computer service, and, depending on these service data, defining one or multiple service types constituting said computer service,
stablishing a correspondence between the service types and at least a portion of the module categories, in order to generate a list of modules suitable for being used to implement each service type.

A user of computer means implementing the method, such as an IT service provider for example, can then make a selection from the list of modules with a view to deploying said computer service.

The invention allows selecting, or even deploying, computer services for a particular need within a very short time. The service can be selected within a few minutes, while several weeks were required in the prior art. In addition, there is no need to mobilize human resources to gather all the modules required to implement each component service of the service to be deployed. It is understood that the economic gain is therefore substantial.

It is understood that making use of the present invention allows ensuring, automatically and without excessive user intervention, technical compatibility between computer modules (hardware and/or software) selected via the invention, and a target platform (OS environment, memory and processor capacity, etc.), in particular by means of the classes created in the various module categories.

In an advantageous embodiment, the method further comprises:
a step of verifying the IT compatibility of computer modules in the created list, with a platform in the computer service to be deployed, and
a step of reducing the list according to the incompatibility of at least some of the modules in the list, which are then removed from the list.

In one exemplary embodiment, this verification of compatibility relies on the creation of a compatibility matrix identifying all modules suitable for use in the deployment of a given type of service.

Advantageously, these stages of verification and list reduction are applied automatically by the computer means available to the service provider. To this end, these computer resources are carefully programmed to check the module data for compatibilities or incompatibilities of each module with the deployment context of the service (for example the minimum memory or processor requirements for executing a software module, the operating system version required, or usage limitations, for example in terms of number of users per module, etc.).

For example, the data relating to a computer module may contain:
prerequisites concerning the computer resources necessary for deployment of the module, and
usage limitation data for the module.

In one embodiment, the method further comprises a step of determining, based on said list, a plurality of module sets, each set comprising a group of modules necessary and sufficient for implementing a service type. The service provider can thus advantageously choose among several possible solutions of module groups that would allow deploying a type of service.

Advantageously, to assist with the choice by the service provider, the method may include ranking said plurality of module sets according to a selected criterion, for example a cost criterion. In such an embodiment, the integrated procurement functions in a computer program in the meaning of the invention provide optimized management of the module selection, particularly in terms of production costs.

In general, the data relating to a computer module may include, in one embodiment, at least data concerning the:
IT category of the module,
module description,
reference identifier for the module and name of module vendor,
module usage unit and price per module unit.

In one embodiment, the data relating to the computer service may include, for each service type:
data describing the service type,
a set of parameters necessary and sufficient for configuring the service type.

An advantageous feature that can be implemented in a particular embodiment relates to automated deployment of the actual service. In such an embodiment, the method comprises a step of deployment of the computer service, and the data relating to a computer module may therefore comprise data concerning:
access to the module, for deployment of the module (for example via a web address or URL, or other), and
module configuration, including for example a set of parameters and/or configuration files associated with the module to be deployed.

Another advantageous feature concerns feedback on usage of the software modules after deployment. Thus, in one embodiment, a step of the method subsequent to deployment of the service comprises the creation of a usage report indicating the number of units used for each computer module by a given customer, and a price for the computer module provided to that customer, per unit used, which is particularly useful feedback information for publishers of software modules or hardware vendors.

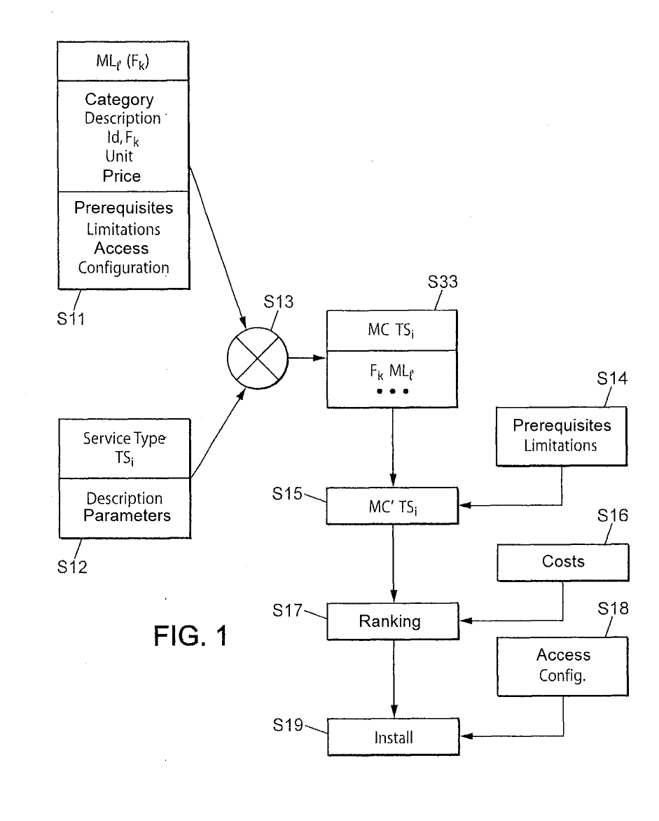

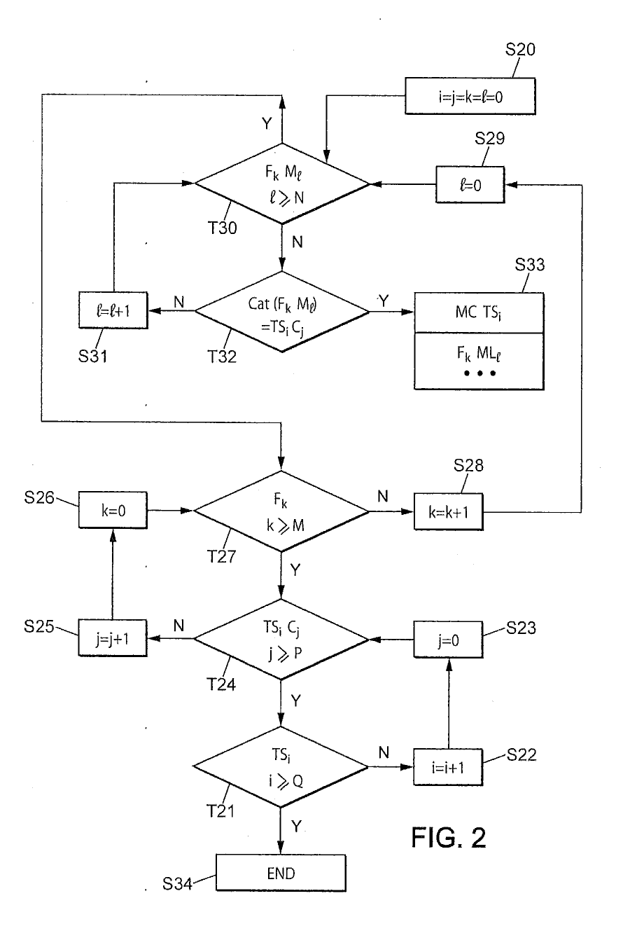

The invention also relates to a computer program comprising instructions for implementing the above method when that program is executed by a processor. For example, represented in FIGS. 1 and 2, discussed further below, are some possible flowcharts for the general algorithms of such a computer program.

This program can be executed by computer means comprised in a device in the meaning of the invention, for example a computer typically comprising means such as a processor, a working memory, a communication interface, etc., for implementing the method. Such a device may include in particular a storage medium (removable or permanent) which holds the instructions of the computer program for implementing the invention.

The invention also relates to such a device comprising computer means for selecting optimal computer modules for deploying a computer service, said computer means being arranged so as to:
based on data relating to a plurality of computer modules, classify the modules at least by categories,
based on data relating to the computer service, define one or more service types constituting said computer service,
establish a correspondence between said service types and at least a portion of said module categories, in order to generate a list of modules suitable for being used to implement each service type.

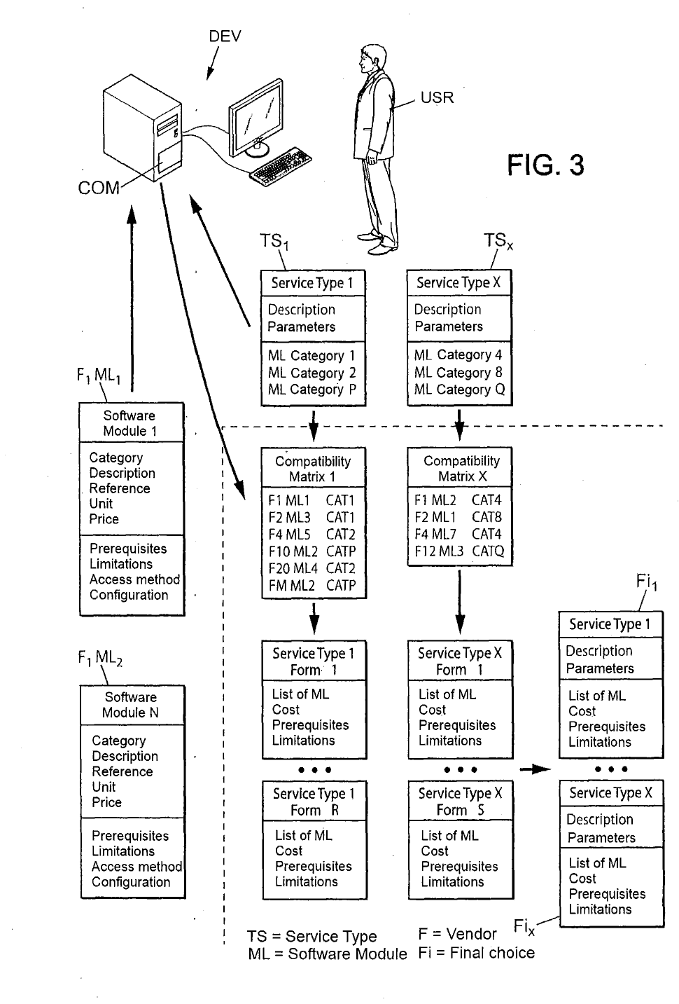

An example of this is schematically represented in FIG. 3 as a computer DEV.

Other features and advantages of the invention will be apparent on reading the following detailed description of some possible embodiments which are non-limiting, and on examining the accompanying drawings in which:

FIG. 1 illustrates the main steps of a method according to one embodiment of the invention,

FIG. 2 illustrates the details of some of the steps of the method of FIG. 1, in an exemplary embodiment,

FIG. 3 illustrates a device according to the invention which implements said method,

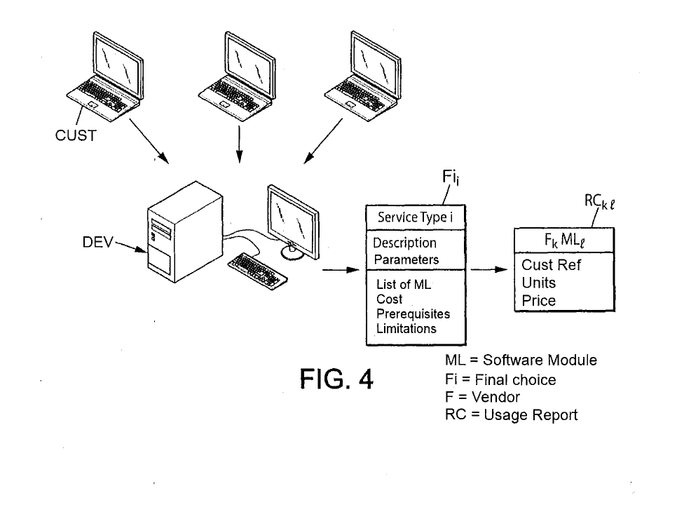

FIG. 4 illustrates an embodiment of an additional step of obtaining a usage report for computer modules provided for a given service.

Referring to FIG. 1, the illustrated method begins with a first step S11 consisting of establishing an inventory of all the computer modules, hereinafter referred to as “software modules” MLₗ, available from vendors Fₖ of software solutions (or at least a subset for which the entity making use of the method has distribution rights).

Each software module MLₗ is characterized by two sets of parameters.

A first set of parameters concerns the descriptive parameters relating to:
the IT category of the software module, for example a communication software module, a backup software module, or a security software module,
the description of the software module, in order to understand its features in more detail,
a unique product reference identifier, and a provider name for the module Fₖ,
a usage unit for the software module, for example usage by user, usage by machine processor (computer, server, or other), usage by gigabyte of storage provided for the service, or other,
a price per module unit.

A second set of parameters concerns parameters relating to the technical specifications for its use, such as:
a prerequisite for the number of processors, or processor gigahertz value, or number of gigabytes of memory, or minimum storage for installation and execution of the module, as well as the operating system supported,
usage limitations such as incompatibility with other software modules or maximum number of module units (users, processors, etc.)
access to the module, for example via a download link, or via direct access if the module is already hosted,
module configuration in order to determine for example whether a set of parameters and/or configuration files are associated with the module to be installed.

A second inventory identifies in step S12 the list of service types making use of one or more software modules. A service type TSᵢ can be characterized by:
a description of the service type (for example a backup service and/or email service), and
a set of parameters necessary and sufficient for configuring the service type (for example a domain name in the case of an email service).

In one embodiment, the different service types TSᵢ can be divided into several categories of modules TSᵢCⱼ that could satisfy each service type (for a service type TSᵢ and an associated category Cⱼ). These categories TSᵢCⱼ are necessary and sufficient for creating the service (for example a virtual server software module, an email server module, an antivirus and anti-spam module for an email service).

In step S13, a list is then generated that defines the modules most suitable for the type of service required.

A service catalog generation function is applied for this purpose, which takes as input the list of categories of software modules and the list of service types. This function calculates a compatibility matrix in the manner represented in one possible embodiment in FIG. 2.

In FIG. 2, nested processing loops are identified such that:

for each service type TSᵢ (loop comprising test T21, the incrementing S22 of the loop counter i, and the initialization S23 of the next loop counter j),
for each service type category TSᵢCⱼ (loop comprising test T24, the incrementing S25 of the loop counter j, and the initialization S26 of the next loop counter k),
   for each software module vendor Fₖ (loop comprising test T27, the incrementing S28 of the loop counter k, and the initialization S29 of the next loop counter l),
      and for each software module FₖMLₗ (loop comprising test T30 and the incrementing S31 of the loop counter l),
         if the category of the software module FₖMLₗ corresponds to the category of the required service type TSᵢCⱼ (test T32), this software module FₖMLₗ is added to the list MC TSᵢ in step S33.

Of course, a first step S20 of initializing the loop counters is provided. When all service types TSᵢ in the general service required have been exhausted (Yes from test T21), then the method can stop at step S34 and the list of possible modules FₖMLₗ for establishing the requested service is finally obtained in step S33.

The generated list MC TSᵢ may initially include several modules for the same category of service, but it is then refined, first according to criteria such as prerequisites and limitations, by excluding modules that do not meet these criteria.

For each set (prerequisites, limitations) defined according to the data S14 in FIG. 1, a refined list S15 is created by selecting software modules compatible with the intended application, by category “Category (FₖMLₗ).” This refined list thus corresponds to a compatibility matrix of the modules, explained below with reference to FIG. 3. This refined list can then be ordered according to an additional predetermined criterion in step S16, in order to present a choice of software modules ranked according to this criterion in step S17 of FIG. 1. This ranking allows the user to make a final choice of a set of modules necessary and sufficient for implementing each service type, as detailed below in reference to FIG. 3.

This additional criterion defined in step S16 may be, for example, the total cost of the modules for all categories providing a particular service, or alternatively may be based for example on the performance of these modules or their compatibility with each other.

The service provider can then make its choice, for example on the basis of this total cost. The method may optionally then continue by providing information on access conditions and configurations for the software modules in step S18, in order to define the conditions for their installation in step S19.

After the service is selected from the ranked list in step S17, the service provider then specifies the configuration parameters in step S18 in order to apply a second function, deployment of the service, implemented in step S19. This second function takes as input a service type and the final choice by the user of a set of modules selected by the service provider user as necessary and sufficient for deploying this service type. For example, for each software module in the list MLₗ, access method MAₗ is used to deploy each module and the configuration information for this module is then applied using the service parameters specified by the vendor.

The service can then be tested and delivered to the end customers.

FIG. 3 shows the method up to the service provider choosing an appropriate set of modules, implemented by computer means available to the service provider.

A user USR that is an IT service provider to third parties and is itself a customer of software module vendors, has access to computer means such as a computer DEV typically comprising a processor, a working memory, and communication means COM for receiving:
informational data from software module vendors, and
data from its customers describing their requirements, in order to define a general service to be provided and, from this, the corresponding service types.

A computer program according to the invention that is executed by the device DEV in order to carry out the method according to the invention, generates, from data concerning the software modules, a description record FₖMLₗ specific to each module, including as indicated above by way of example, organized data relating to the module category, a short description, its reference and publisher, its usage unit, its price, installation prerequisites, limitations, the access method, and its configuration. This description record typically can include tags (such as a brief description of the software module, or its identifier, etc.) for interpreting these records in an object-oriented language (for example Java or some other language), thus with a possibility of defining classes of categories, descriptions, etc.

The computer program installed on the device DEV of the user USR generates, from data concerning the services required by the customer, a description record TS; including, as indicated above by way of example, organized data relating to a description of the service type, parameters specific to that service type. This description record TS1, . . . , TSx, further comprises categories of software modules ML Category 1, 2, . . . , which are suitable for providing the service type required (corresponding to parameter TSᵢCⱼ presented above).

In one exemplary embodiment, the method further comprises, for the generation of the compatibility matrices 1, . . . , x, the detailed steps illustrated in FIG. 2. In one embodiment, each matrix can be refined and then ordered according to a selected criterion (cost, technical performance, compatibility of a module with a module of another service type, etc.). Each compatibility matrix is thus converted into several description records, each having a particular set of modules ML which together are able to provide a service type defined in the compatibility matrix. This record contains the set of modules necessary and sufficient for providing this service type, with the total cost of all of these modules, the installation prerequisites, and the usage limitations.

In one embodiment, these records of module sets may be ranked according to a chosen criterion, for example a cost criterion, and the user can thus simply select the first set of modules that appears in this ranked list or can make some other choice, for example based on time to delivery, vendor reliability, or some other criterion.

Thus, with reference to FIG. 3, in a particular embodiment of the invention the user USR makes a final choice Fi₁, . . . , Fiₓ for each service type, retaining a specific list of modules chosen for each service type.

Another functionality may also be provided: usage reporting. This is run periodically, for example every month. This functionality takes as input the latest information concerning service usage, for example the number of users of the software modules, the storage used for example when hosted on a remote server as part of a cloud-based service, or the number of emails sent/received, etc. Referring to FIG. 4, once the service is deployed with one or more customers CUST, for each deployed service Fiᵢ and for each vendor Fₖ of the software module MLₗ used in the deployed service, the method can continue with a step of creating a usage report RCₖₗ containing, for example, data concerning:
the reference for the customer CUST,
the number of units used (gigabytes actually used, number of times the module was used, etc.)
the price of the computer resource provided to the customer, per unit used, which allows the software publisher or hardware vendor to obtain valuable information about usage of the material sold.

Of course, the invention is not limited to the embodiments described above as examples; it extends to other variants.

For example, the content of the records describing each software module is presented here by way of example and there can be variants. For example, the fields concerning the module category and description can be grouped into one field. Similarly, there can be variants in the content of the computer record describing a service type.

Similarly, the detailed steps of the method according to FIG. 2, or at least a portion of the steps of FIG. 1, are presented here as examples and are subject to variations according to the hardware/software design chosen.

In addition, based on feedback concerning a complete set of modules selected by a user, some records in the set of modules may change over time (for example their removal when there is proven incompatibility between several modules in a set, or conversely the creation of records for new software products that have been released).

1. A method implemented by computer means, for selecting optimal computer modules for deployment of a computer service, the method comprising the steps of:
obtaining data relating to a plurality of computer modules, and, depending on said module data, classifying the modules at least by categories,
obtaining data relating to the computer service, and, depending on said service data, defining one or multiple service types constituting said computer service,
establishing a correspondence between said service types and at least a portion of said module categories, in order to generate a list of modules suitable for being used to implement each service type, which allows the selection of modules from said list with a view to deploying the service.

2. The method according to claim 1, further comprising a step of verifying the IT compatibility of computer modules in said list with a platform in said computer service, and a step of reducing said list according to the incompatibility of at least some of the modules in the list.

3. The method according to claim 1, further comprising a step of determining, based on said list, a plurality of module sets, each set comprising a group of modules necessary and sufficient for implementing a service type.

4. The method according to claim 3, comprising a ranking of the plurality of module sets according to a selected criterion.

5. The method according to claim 4, wherein said selected criterion is a cost criterion.

6. The method according to claim 1, comprising, subsequent to deployment of the service, a step comprising the creation of a usage report indicating a number of units used for each computer module by a given customer, and a price for the computer module provided to that customer, per unit used.

7. The method according to claim 1, wherein the data relating to a computer module comprise at least data concerning the:
IT category of the module,
module description,
reference identifier for the module and name of module vendor,
module usage unit and price per module unit.

8. The method according to claim 2, wherein the data relating to a computer module further comprises data relating to:
prerequisites concerning the computer resources necessary for deployment of the module, and
usage limitations for the module.

9. The method according to claim 1, comprising a step of deployment of the computer service, and wherein the data relating to a computer module further comprises data concerning:
access to the module, for deployment of said module, and
module configuration, in particular including a set of parameters and/or configuration files associated with the module to be deployed.

10. The method according to claim 1, wherein the data relating to the computer service comprise, for each service type:
data describing the service type,
a set of parameters necessary and sufficient for configuring the service type.

11. (canceled)

12. A device comprising computer means for selecting optimal computer modules for deploying a computer service, said computer means being arranged so as to:
based on data relating to a plurality of computer modules, classify the modules at least by categories,
based on data relating to the computer service, define one or more service types constituting said computer service,
establish a correspondence between said service types and at least a portion of said module categories, in order to generate a list of modules suitable for being used to implement each service type.

13. A non-transitory computer-readable storage medium with an executable program stored thereon, wherein the program instructs a microprocessor to perform the method according to claim 1.
